(19) United States
(12) Patent Application Publication
(10) Pub. No.: US 2023/0382234 A1
(43) Pub. Date: Nov. 30, 2023

(54) Electric Vehicle Charging System

(71) Applicant: John McLellan, Prescott Valley, AZ (US)

(72) Inventor: John McLellan, Prescott Valley, AZ (US)

(21) Appl. No.: 17/937,526

(22) Filed: Oct. 3, 2022

Related U.S. Application Data
(60) Provisional application No. 63/347,052, filed on May 31, 2022.

(51) Int. Cl. B60L 8/00; B60W 10/08; B62D 25/08

(52) U.S. Cl. CPC B60L 8/006; B60W 10/08; B62D 25/084

(57) ABSTRACT

The present invention relates to an electric vehicle charging system comprised of at least one duct, at least one fan, at least one fan pulley wheel and fan pulley wheel band, and at least one alternator with at least one alternator pulley wheel. The duct is positioned behind a grill of an electric vehicle such that air is funneled through the duct and into the fan, causing the fan to spin which turns an alternator through a series of pulleys such that the alternator charges the battery of the electric vehicle.

### CROSS-REFERENCE TO RELATED APPLICATION

The present application claims priority to, and the benefit of, U.S. Provisional Application No. 63/347,052, which was filed on May 31, 2022, and is incorporated herein by reference in its entirety.

### FIELD OF THE INVENTION

The present invention relates generally to the field of electric vehicles. More specifically, the present invention relates to an electric vehicle charging system comprised of at least one duct, at least one fan, at least one fan pulley wheel and fan pulley wheel band, and at least one alternator with at least one alternator pulley wheel. The duct is positioned behind a grill of an electric vehicle such that air is funneled through the duct and into the fan, causing the fan to spin, which turns an alternator through a series of pulleys such that the alternator charges the battery of the electric vehicle. Accordingly, the present disclosure makes specific reference thereto. Nonetheless, it is to be appreciated that aspects of the present invention are also equally applicable to other like applications, devices, and methods of manufacture.

### BACKGROUND

Electric vehicles are becoming increasingly popular across the United States. However, said vehicles can only be used for a short period of time before needing to be recharged. As a result, taking long trips with an electric vehicle can be difficult due to the lack of charging stations available on major roadways. Further, if an electric vehicle dies because there are no nearby charging stations, drivers will become stranded and cannot reach their destination.

Therefore, there exists a long-felt need in the art for an improved system that extends the battery life of an electric vehicle. There also exists a long-felt need in the art for an electric vehicle charging system that charges an electric vehicle while driving passively. There also exists a long-felt need in the art for an electric vehicle charging system that charges an electric vehicle while driving passively, wherein the system prolongs battery life and maintains a flowing current. Further, there exists a long-felt need in the art for an electric vehicle charging system that offers a convenient means of charging an electric vehicle while also maximizing the amount of time an electric vehicle can be driven.

The subject matter disclosed and claimed herein, in one embodiment thereof, comprises an electric vehicle charging system. The system is comprised of at least one duct, at least one fan, at least one fan pulley wheel and fan pulley wheel band, and at least one alternator with at least one alternator pulley wheel. The duct is positioned behind a grill of an electric vehicle such that air is funneled through the duct and into the fan, causing the fan to spin. The spinning of the fan causes the fan pulley wheel to spin such that the fan pulley wheel band spins the alternator pulley wheel. The spinning of the alternator pulley wheel turns the alternator such that the alternator charges the battery of the electric vehicle.

In this manner, the electric vehicle charging system of the present invention accomplishes all of the foregoing objectives and provides a system that extends the battery life of an electric vehicle while driving passively. During use, the system prolongs battery life and maintains a flowing current. Furthermore, the system offers a convenient means of charging an electric vehicle while also maximizing the amount of time an electric vehicle can be driven.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric vehicle charging system comprised of at least one duct, at least one fan, at least one fan pulley wheel and fan pulley wheel band, and at least one alternator with at least one alternator pulley wheel. The system is intended to be used with any electric vehicle known in the art having at least one battery.

The system is comprised of at least one duct with at least one opening positioned behind a grill of the electric vehicle. The grill preferably allows air to pass through the grill and into the duct. The duct is preferably a funnel-like shape that increases the velocity of air as it passes through the duct. The air is funneled to at least one fan within or positioned opposite the opening of the duct.

The fan is spun by the air directed through the duct causing at least one fan pulley wheel to spin 360 degrees around at least one fan pulley wheel axle. In the preferred embodiment, the fan pulley wheel is a 12-inch diameter wheel. The system is also comprised of at least one alternator, comprised of at least one alternator pulley wheel that spins 360 degrees around at least one alternator pulley axle. In the preferred embodiment, the alternator pulley wheel is preferably a 3-inch diameter wheel to create a 4-to-1 ratio with the fan pulley wheel to optimize power generated.

The band of the fan pulley wheel is further attached to the alternator pulley wheel such that the spinning of the fan due to air moving through the duct spins the fan pulley wheel causing the band to spin around the alternator pulley wheel which turns the alternator. This creates an electric charge that can be transferred to the battery of the vehicle. As a result, air taken into the duct while driving can be used to charge the battery while the vehicle drives using a passive process.

Accordingly, the electric vehicle charging system of the present invention is particularly advantageous as it provides a system that extends the battery life of an electric vehicle. Further, the system does so while the vehicle is driving passively. The system also prolongs battery life and maintains a flowing current. In addition, the system offers a convenient means of charging an electric vehicle while also maximizing the amount of time an electric vehicle can be driven. In this manner, the electric vehicle charging system overcomes the limitations of existing electric vehicles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an electric vehicle charging system of the present invention while installed within an electric vehicle in accordance with the disclosed architecture;

FIG. 2 illustrates an enhanced perspective view of a duct of one potential embodiment of an electric vehicle charging system of the present invention while installed within an electric vehicle in accordance with the disclosed architecture;

FIG. 3 illustrates an enhanced perspective view of a fan and pulleys of one potential embodiment of an electric vehicle charging system of the present invention while installed within an electric vehicle in accordance with the disclosed architecture; and

FIG. 4 illustrates a flowchart of a method of using one potential embodiment of an electric vehicle charging system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved system that extends the battery life of an electric vehicle. There also exists a long-felt need in the art for an electric vehicle charging system that charges an electric vehicle while driving passively. There also exists a long-felt need in the art for an electric vehicle charging system that charges an electric vehicle while driving passively, wherein the system prolongs battery life and maintains a flowing current. Further, there exists a long-felt need in the art for an electric vehicle charging system that offers a convenient means of charging an electric vehicle while also maximizing the amount of time an electric vehicle can be driven.

The present invention, in one exemplary embodiment, is comprised of an electric vehicle charging system. The system is comprised of at least one duct, at least one fan, at least one fan pulley wheel and fan pulley wheel band, and at least one alternator with at least one alternator pulley wheel. The system is intended to be used with any electric vehicle known in the art having at least one battery.

More specifically, the system is comprised of at least one duct with at least one opening. The duct is positioned behind a grill of the electric vehicle. The grill preferably allows air to pass through the grill and into the duct, which is preferably a funnel-like shape that increases the velocity of air as it passes through the duct. The air is funneled to at least one fan within or positioned opposite the opening of the duct.

As a result, the fan is spun by the air directed through the duct thereby causing at least one fan pulley wheel to spin 360 degrees around at least one fan pulley wheel axle. In the preferred embodiment, the fan pulley wheel is a 12-inch diameter wheel. The system is also comprised of at least one alternator, comprised of at least one alternator pulley wheel that spins 360 degrees around at least one alternator pulley axle. In the preferred embodiment, the alternator pulley wheel is preferably a 3-inch diameter wheel to create a 4-to-1 ratio with the fan pulley wheel to optimize power generated.

The band of the fan pulley wheel is further attached to the alternator pulley wheel such that the spinning of the fan due to air moving through the duct spins the fan pulley wheel causing the band to spin around the alternator pulley wheel which turns the alternator. This creates an electric charge that can be transferred to the battery of the vehicle. As a result, air taken into the duct while driving can be used to charge the battery while the vehicle drives using a passive process.

Accordingly, the electric vehicle charging system of the present invention is particularly advantageous as it provides a system that extends the battery life of an electric vehicle. Further, the system does so while the vehicle is driving passively. The system also prolongs battery life and maintains a flowing current. In addition, the system offers a convenient means of charging an electric vehicle while also maximizing the amount of time an electric vehicle can be driven. In this manner, the electric vehicle charging system overcomes the limitations of existing electric vehicles known in the art.

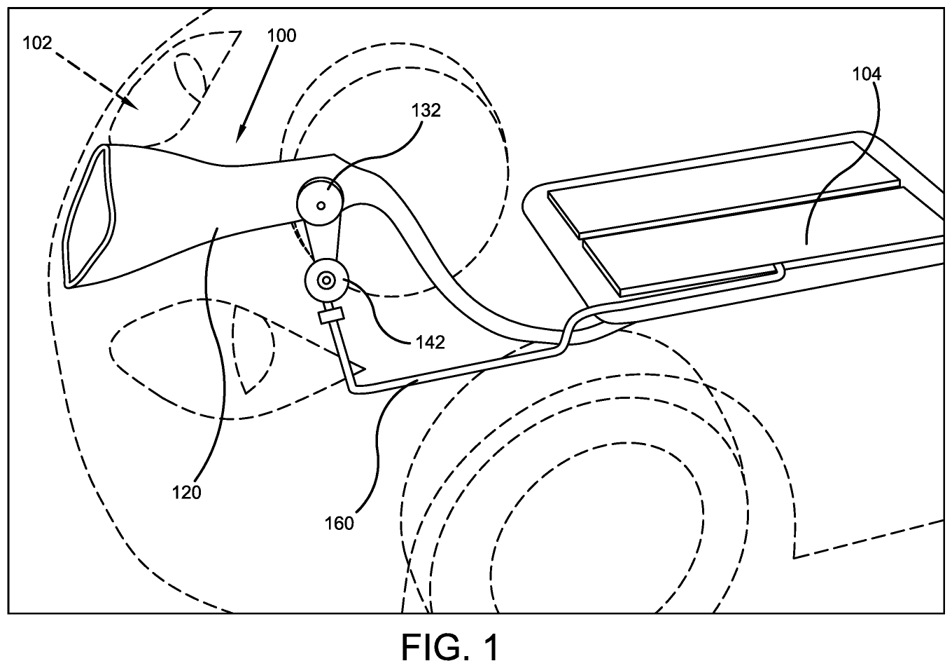

Referring initially to the drawings, FIG. 1 illustrates a perspective view of one potential embodiment of an electric vehicle charging system 100 of the present invention while installed within an electric vehicle 102 in accordance with the disclosed architecture. The system 100 is comprised of at least one duct 120, at least one fan 130, at least one fan pulley wheel 132 and fan pulley wheel band 136, and at least one alternator 140 with at least one alternator pulley 142. The system 100 is intended to be used with any electric vehicle 102 known in the art having at least one battery 104. It is appreciated that the system 100 is compatible with lithium-ion, nickel-metal hydride, lead-acid, ultracapacitor batteries, or any battery 104 type known in the art of electric vehicles 102. In one embodiment, the system 100 is comprised of an electric vehicle 102. In another embodiment, the system 100 can be employed on an existing electric vehicle 102 known in the art.

Unless otherwise specific herein, all components of the system 100 may be made from a durable metal material such as, but not limited to, stainless steel or aluminum, carbon fiber, or a rigid plastic such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

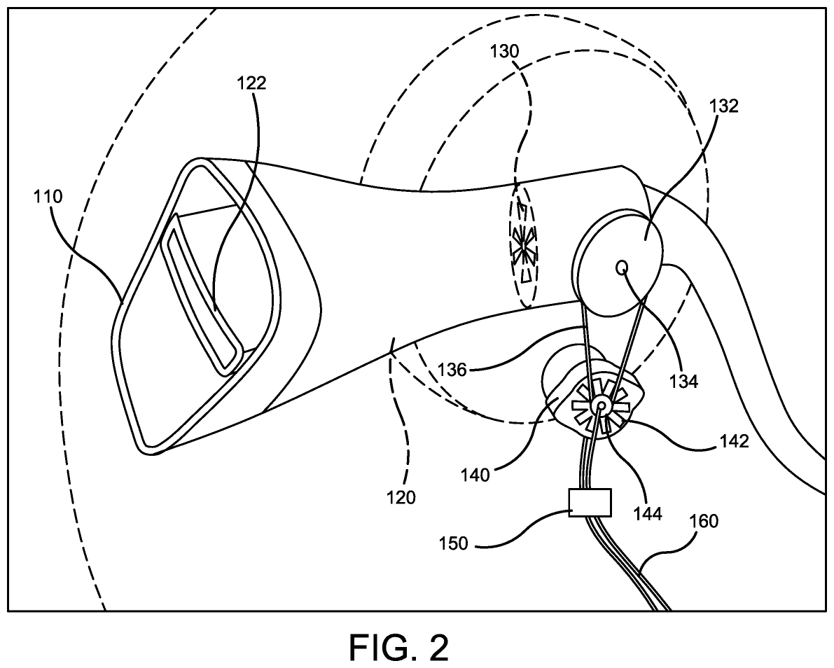

FIG. 2 illustrates an enhanced perspective view of a duct 120 of one potential embodiment of an electric vehicle charging system 100 of the present invention while installed within an electric vehicle 102 in accordance with the disclosed architecture. The system 100 is comprised of at least one duct 120 with at least one opening 122. The duct 120 is preferably positioned behind a grill 110 of the electric vehicle 102 and is larger in size than the grill 110. The grill 110 is preferably a perforated grill and/or has at least one opening that allows air to pass through the grill 110 and into the duct 120. The duct 120 is preferably a funnel-like shape but may be any shape known in the art that is conducive to collecting air from the grill 120. It should also be noted that because the duct 120 is larger than the grill 110, it collects the maximum amount of air that passes through the grill 110 and funnels the air to at least one fan 130 within or positioned opposite the opening 122 of the duct 120. Because of the funnel-like shape of the duct 120, the velocity of air within the duct 120 is increased as air moves through the duct 120 toward the fan 130. It should be appreciated that the duct 120 may be any shape that is intended to increase the velocity of air moving through the duct 120 the fan 130.

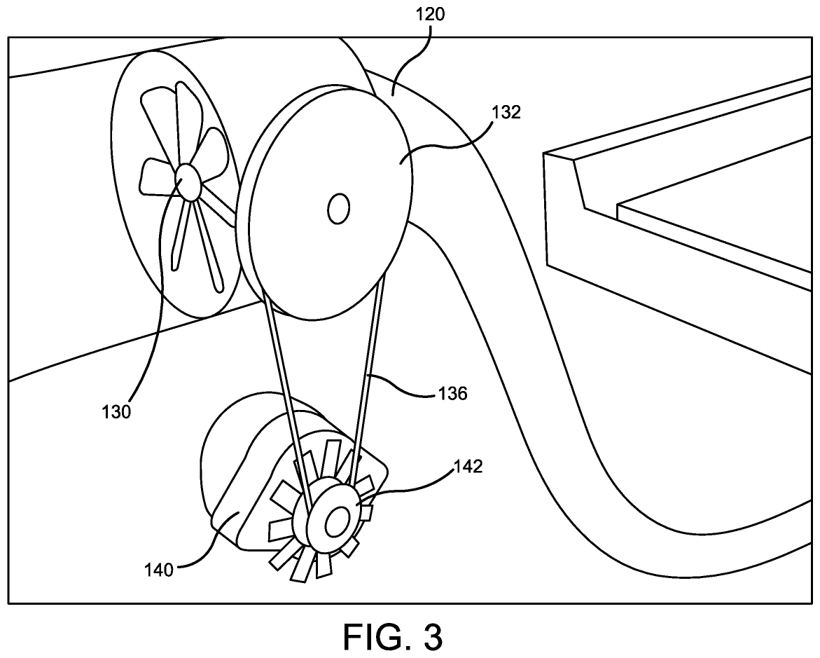

FIG. 3 illustrates an enhanced perspective view of a fan 130 and pulleys 132,142 of one potential embodiment of an electric vehicle charging system of the present invention while installed within an electric vehicle in accordance with the disclosed architecture. The fan 130 may be any fan type known in the art of vehicles. The fan 130 is spun by the air directed through the duct 120. As the fan 130 spins, at least one fan pulley wheel 132 spins 360 degrees around at least one fan pulley wheel axle 134. In the preferred embodiment, the fan pulley wheel 132 is a 12-inch diameter wheel. However, the wheel 132 may be any size/diameter in different embodiments of the system 100.

The system 100 is also comprised of at least one alternator 140 of the type that may be used in an electric vehicle or other non-electric vehicle. In the preferred embodiment, the alternator 140 is a 100-amp alternator. In another embodiment, the alternator 140 is a DC-to-DC converter. The alternator 140 is comprised of at least one alternator pulley wheel 142 that spins 360 degrees around at least one alternator pulley axle 144. In the preferred embodiment, the alternator pulley wheel 142 is preferably a 3-inch diameter wheel to create a 4-to-1 ratio with the fan pulley wheel 142 to optimize power generated. However, the alternator pulley wheel 142 may be any size or diameter known in the art to form any ratio with the fan pulley wheel 142.

The band 136 of the fan pulley wheel 132 is further attached to the alternator pulley wheel 142. In this manner, the spinning of the fan 130 due to air moving through the duct 120 spins the fan pulley wheel 132, wherein the band 136 spins around the alternator pulley wheel 142 and the alternator pulley wheel 142 turns the alternator 140. This creates an electric charge that can be transferred to the battery 104 of the vehicle 102 via at least one piece of electrical wiring 160. As a result, air taken into the duct 120 while driving can be used to charge the battery 104 while the vehicle 102 drives using a passive process.

The band 136 is preferably comprised of a reinforced rubber material. The band 136 is also preferably oil and heat resistant. The band 136 is also preferably static dissipating.

In one embodiment, the system 100 may also be comprised of at least one alternator electronic 150. The electronic 160 may include, but is not limited to, a voltage regulator or any other device that aids in the proper functioning of the alternator 140.

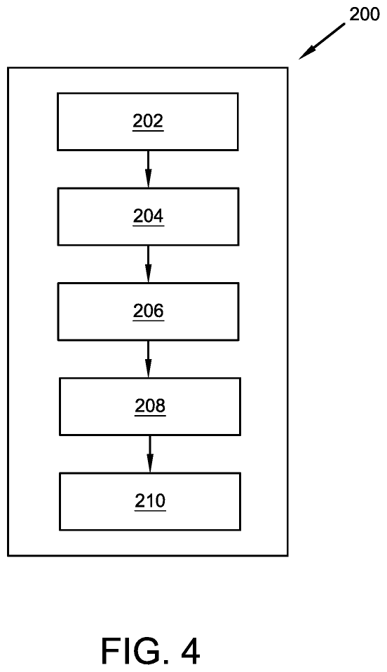

FIG. 4 illustrates a flowchart of a method 200 of using one potential embodiment of an electric vehicle charging system 100 of the present invention in accordance with the disclosed architecture. The system 100 is also comprised of a method of use 200. First, the system 100 is installed on an electric vehicle 102 and the same is then driven [Step 202]. Then, as the vehicle 102 travels, air travels through the grill 110 and is collected by a duct 120 [Step 204]. The duct 120 moves the air to at least one fan 130 within the duct 120, wherein the air increases in velocity within the duct 120 and spins the fan 130 [Step 206]. Next, the spinning of the fan 130 rotates a fan pulley wheel 132, which in turn rotates an alternator pulley wheel 142 connected to the fan pulley wheel 132 via a fan pulley wheel band 136 [Step 208]. As a result, the alternator pulley wheel 142 turns the alternator 140 which in turn charges the battery 104 of the vehicle 102 passively while driving [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric vehicle charging system” and “system” are interchangeable and refer to the electric vehicle charging system 100 of the present invention.

Notwithstanding the foregoing, the electric vehicle charging system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the electric vehicle charging system 100 as shown in the FIGS. are for illustrative purposes only, and that many other sizes and shapes of the electric vehicle charging system 100 are well within the scope of the present disclosure. Although the dimensions of the electric vehicle charging system 100 are important design parameters for user convenience, the electric vehicle charging system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric vehicle charging system comprising:
a duct;
a fan;
a fan pulley wheel;
a fan pulley wheel band;
an alternator pulley wheel; and
an alternator.

2. The electric vehicle charging system of claim 1, wherein the electric vehicle charging system is installed within an electric vehicle.

3. The electric vehicle charging system of claim 2, wherein the duct is positioned behind a grill of the electric vehicle.

4. The electric vehicle charging system of claim 3, wherein the duct is larger in size than the grill.

5. The electric vehicle charging system of claim 4, wherein the duct is comprised of a funneled shape that increases the velocity of air traveling through the duct.

6. The electric vehicle charging system of claim 1, wherein the alternator is comprised of a DC-to-DC converter.

7. The electric vehicle charging system of claim 2, wherein the electric vehicle charging system charges the electric vehicle.

8. The electric vehicle charging system of claim 1, wherein the alternator is in electrical communication with a battery of the electric vehicle via a wiring.

9. An electric vehicle charging system comprising:
a duct;
a fan positioned within the duct;
a fan pulley wheel attached to the fan;
an alternator pulley wheel attached to an alternator; and
a fan pulley wheel band attached to the fan pulley wheel and the alternator pulley wheel.

10. The electric vehicle charging system of claim 9, wherein the fan pulley wheel is comprised of a first size and the alternator pulley wheel is comprised of a second size, wherein the first size and the second size achieve a 4-to-1 size ratio.

11. The electric vehicle charging system of claim 9, wherein the alternator is comprised of a 100-amp alternator.

12. The electric vehicle charging system of claim 9, wherein the spinning of the fan spins the fan pulley wheel.

13. The electric vehicle charging system of claim 12, wherein the spinning of the fan pulley wheel spins the alternator pulley wheel.

14. The electric vehicle charging system of claim 13, wherein the spinning of the alternator pulley wheel turns the alternator.

15. The electric vehicle charging system of claim 14, wherein the alternator delivers an electrical charge to a battery of an electric vehicle the electric vehicle charging system is installed within.

16. The electric vehicle charging system of claim 9, wherein the fan pulley wheel band is comprised of a rubber material.

17. The electric vehicle charging system of claim 16, wherein the rubber material is heat resistant.

18. The electric vehicle charging system of claim 16, wherein the rubber material is oil resistant.

19. The electric vehicle charging system of claim 9 comprised of a voltage regulator.

20. A method of using an electric vehicle charging system, the method comprising the steps of:
installing the electric vehicle charging system on an electric vehicle, wherein the electric vehicle charging system comprises a duct, a fan positioned within the duct, a fan pulley wheel attached to the fan, an alternator pulley wheel attached to an alternator, and a fan pulley wheel band attached to the fan pulley wheel and the alternator pulley wheel;
driving the electric vehicle; and
charging the electric vehicle passively while driving using the electric vehicle charging system.
